(19) United States
(12) Patent Application Publication
(10) Pub. No.: US 2013/0077102 A1
(43) Pub. Date: Mar. 28, 2013

(54) IMAGE DATA CONVERSION UNIT

(71) Applicant: Hiroki TOMITA, Ibaraki-ken (JP)

(72) Inventor: Hiroki TOMITA, Ibaraki-ken (JP)

(73) Assignee: RISO KAGAKU CORPORATION, Tokyo (JP)

(21) Appl. No.: 13/608,608

(22) Filed: Sep. 10, 2012

(30) Foreign Application Priority Data
Sep. 28, 2011 (JP) P2011-212823

(51) Int. Cl. G06K 15/02

(52) U.S. Cl. 358/1.2

(57) ABSTRACT

An image data conversion unit includes a halftone processor to generate drop data relating to the number of ink liquid drops from information about the density of each pixel in image data, a data replacer to divide image data into predetermined sized unit areas, calculate a pixel pattern in which the same gradation pixels appear continuously for each unit area in accordance with the density in each unit area, and replace the pixels included in each unit area with a pixel pattern calculated for the unit area, and a mode switcher to select one of standard mode in which drop data is generated by inputting image data to the halftone processor and first data compression mode in which after image data is input to the data replacer and compressed, drop data is generated in the halftone processor and switch the image data processing orders in accordance with the selected mode.

### BACKGROUND OF THE INVENTION

1. Technical Field

The present invention relates to an image data conversion unit that converts document image data into gradation data for printing in accordance with the density of each pixel and outputs the data after compression processing when printing a document image in an inkjet printer, laser printer, stencil printing, and another image forming device.

2. Background Arts

In general, an image forming device, such as a printing device, is connected to a data processing device, such as a computer, via a network and receives job data (drop data that a printing device can output), which is a print job, transmitted from the data processing device, temporarily stores the job data in a data storage unit, and performs printing in order of reception.

There is a tendency for job data to increase in capacity as the resolution of printed matter increases. For example, when job data is data having a large file capacity, such as a PDF format file corresponding to several hundreds of pages, it takes time to transfer data from the data processing device to the image forming device. Consequently, it is not possible to transfer data to the image forming device at such high speed as to synchronize with printing processing. As a result, there is a case where printing takes a long time even if an image forming device for high-speed printing is used. Particularly, in recent years, an image forming device is requested to increase the speed of printing processing and it becomes necessary to transfer job data to an image forming device in synchronization with printing speed.

In order to solve the problems described above, in Japanese Patent Application Laid-Open No. 2010-221518, there is proposed a technique to reduce the file capacity by calculating the file capacity of input image data and by reducing the number of gradations (number of bits) when the file capacity is large. Further, as a publicly-known technique, an algorithm for high compression of data is also proposed.

### SUMMARY OF THE INVENTION

However, the technique disclosed in the above-mentioned Patent Document is a technique to perform printing processing by performing compression processing of input image data based on a complicated compression algorithm on the side of the image forming device, and therefore, if data with a large file capacity is input to the image forming device, the load on the device side increases, resulting in delay of printing processing. In such a case, it is not possible to synchronize the transfer speed of job data with the speed of printing processing, and as a result, the speed of printing processing is reduced. On the other hand, the algorithm for high compression of data is effective for specific data highly adaptable to the algorithm, but not necessarily effective for other data. For example, data in which the same value appears continuously, such as “11112222333333444”, is highly adaptable to compression and it is easy to compress. In contrast to this, data in which the same value rarely appears continuously, such as “123441223411234”, is less adaptable to compression and it is hard to compress. Therefore, it is not possible to highly compress all the data uniformly and there is a case where the compression time increases depending on the kind of job data.

The present invention has been made in view of the above problems and an object thereof is to provide an image data conversion unit capable of aiming at a reduction in file capacity of job data to be subjected to printing processing and at an increase in printing processing speed in an image forming device by a very versatile technique without the need to use a complicated compression algorithm.

In order to achieve the above-mentioned object, an image data conversion unit according to an embodiment of the present invention is an image data conversion unit that converts document image data into gradation data for printing in accordance with the density of each pixel and outputs the data after compression processing, including a standard mode converter configured to convert the document image data into the gradation data for printing in a predetermined number of gradations, a data compression mode converter configured to convert the document image data into the gradation data for printing in a number of gradations smaller than the predetermined number of gradations so that the continuity of the number of gradations between neighboring pixels is made greater, a mode switcher configured to select one of data conversion by the standard mode converter and data conversion by the data compression mode converter, and a data compressor configured to perform compression processing of the gradation data for printing using data conversion by the mode selected by the mode switcher.

### BRIEF DESCRIPTION OF THE DRAWINGS

FIG. 1 is a conceptual diagram showing a general configuration of a printing system including an image data conversion unit according to a first embodiment.

FIG. 2 is a block diagram showing an internal configuration of a user terminal of FIG. 1.

FIG. 3 is a block diagram showing a module relating to an image data conversion unit constructed virtually on a driver of the user terminal of FIG. 1.

FIGS. 4A and 4B are explanatory diagrams showing the CMY ink used states before and after single color conversion performed in a color converter of FIG. 3.

FIGS. 5A and 5B are explanatory diagrams showing changes in amount of CMY ink of image data before and after single color conversion performed in the color converter of FIG. 3.

FIGS. 6A to 6C are explanatory diagrams showing the states of the replaced pattern replaced in a data replacer of FIG. 3.

FIG. 7 is a flowchart showing image data conversion processing according to the first embodiment.

FIGS. 8A to 8C are explanatory diagrams showing the states of the image data changed by the image data conversion unit of FIG. 1.

FIG. 9 is a block diagram showing an internal module of an image forming device including an image data conversion unit according to a second embodiment.

### DESCRIPTION OF THE EMBODIMENTS

### First Embodiment

A first embodiment of an image data conversion unit according to the present invention is explained below in detail with reference to the accompanying drawings. Here, as a printing device 2 (image forming device), an inkjet line color printer is supposed, which includes a plurality of ink heads in which a number of nozzles are formed, performs printing in units of lines by ejecting a black or color ink from each ink head, and forms a plurality of images on a recording sheet on the transfer belt in an overlapping manner.

(General Configuration of Printing System)

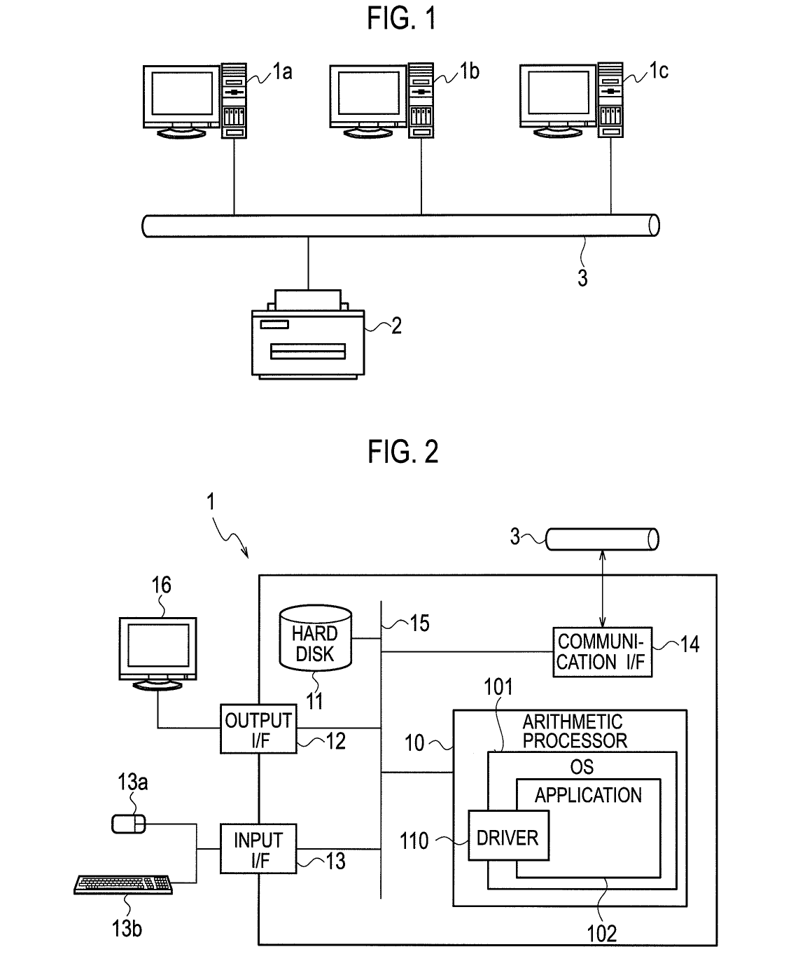

FIG. 1 is a conceptual diagram showing a general configuration of a printing system including the image data conversion unit according to the first embodiment. The image data conversion unit in the present embodiment is configured by installing a data conversion program in a user terminal 1 (1a to 1c) as a driver.

Then, in the present embodiment, as shown in FIG. 1, the printing device 2 and a plurality of the user terminals 1 (1a to 1c) are connected to a network 3. The network 3 is a wireless network, such as a local area network (LAN) and a wireless LAN (WLAN), by 10 BASE-T, 100 BASE-TX, etc., using the communication protocol TCP/IP, and the network 3 also includes a simple network, such as a home network using the pier to pier.

The user terminal 1 (1a to 1c) is an arithmetic processing device having a CPU and includes the function to create image data for printing by various kinds of application software and to instruct the printing device 2 to perform printing processing of the image data through the printer driver software, OS, and firmware. It is possible to implement the user terminal 1 by, for example, a general-purpose computer, such as a personal computer, and a dedicated device the function of which is specialized and may be a mobile computer, PDA (Personal Digital Assistance), and a portable telephone unit, such as a smart phone.

The printing device 2 is an inkjet printer in the present embodiment and forms an image on a print sheet by ejecting ink to the print sheet, which is a recording medium, while changing the number of liquid drops of ink for each pixel in accordance with gradation data for printing configured by a number of pixels in which the density varies in a plurality of levels of gradation. In particular, the printing device 2 has the function as a network printer configured to print a document image by job data (document image data) received from the user terminal 1 through the network 3 in accordance with a printing instruction based on a user's operation.

(Configuration of User Terminal)

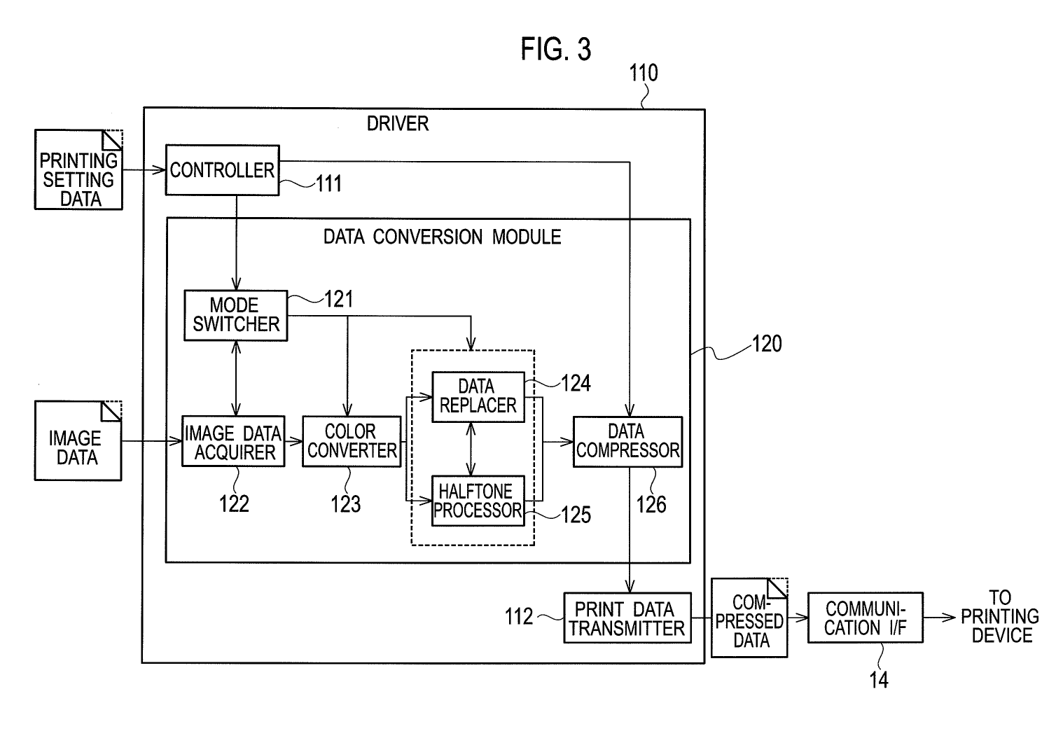

FIG. 2 is a block diagram showing an internal configuration of the user terminal 1 (1a to 1c) and FIG. 3 is a block diagram showing a function module constructed virtually on an arithmetic processor 10 of the user terminal 1 by installing a driver 110. Note that the “module” used in the present embodiment refers to a function unit configured by hardware, such as a device and equipment, software having the function of the hardware, or a combination thereof and configured to achieve a predetermined operation.

As shown in FIG. 2, the user terminal 1 (1a to 1c) includes the arithmetic processor 10 configured to perform various kinds of arithmetic processing, a hard disk 11 configured to save data and data of execution programs etc., an output interface 12 and an input interface 13 configured to input and output data, operation signals, video/audio signals, etc. from and to the user terminal 1, a communication interface 14 configured to perform communication via the network 3, and a bus 15 connecting each of these modules.

Each of the output interface 12 and the input interface 13 is a data transfer module including an external terminal configured to input and output data, video/audio signals, etc. To each of the interfaces 12, 13, devices used generally are connected, specifically, a display device, such as a display 16, a flexible disk drive, a CD-ROM drive, a hard disk drive, input devices, such as a mouse 13a and a keyboard 13b, and transmission and reception of data and signals are performed in a signal format conformant to each device. The communication interface 14 is a communication interface configured to transmit and receive data to and from the printing device 2 and performs data communication using the LAN communication protocol represented by, for example, 10 BASE-T, 100 BASE-TX, etc., the serial system, and the USB system.

The hard disk 11 is a storage device configured to accumulate various kinds of data and to save data input through the input device, such as the mouse 13a and the keyboard 13b, and the result of arithmetic processing by the arithmetic processor 10. Further, in the hard disk 11, switching conditions of the standard mode, the compression mode, and the drop data compression mode relating to data conversion are accumulated.

The arithmetic processor 10 is an arithmetic device including a processor, memory, and other peripherals. In particular, in the present embodiment, an OS 101 is executed on the arithmetic processor 10, an application 102 is executed on the OS 101 and by the OS 101, the driver 110 configured to control each of the components 11 to 14 is executed. By activating a data conversion program, to be described later, on the arithmetic processor 10, a data conversion unit configured to perform data conversion of print data to be transferred to the printing device 2 is constructed virtually, and therefore, it is possible for the user terminal to cause the virtually constructed data conversion unit to function as a data conversion unit.

The driver 110 is a data conversion program executed on the user terminal 1 to control the printing device 2 connected to the user terminal 1. Usually, the driver 10 acquires document data, generates print data, which is image data for printing, in accordance with predetermined printing setting information, sends out the data as job data to the printing device 2 after performing compression processing, and causes the printing device 2 to perform printing processing. Then, the driver 110 performs data conversion processing to reduce the file capacity for the job data relating to printing.

(Configuration of Driver 110)

As shown in FIG. 3, in the present embodiment, the driver 110 includes a controller 111, a print data transmitter 112, and a data conversion module 120 (image data converter).

The controller 111 is a module configured to control the entire operation of the driver 110 and specifically, controls data conversion from image data into drop data in the data conversion module 120, in addition to data transmission and reception, based on the printing setting data. The printing setting data includes information necessary for normal printing, such as the printing mode, document data size, resolution, print sheet size, and printing direction. Moreover, the controller 111 includes a recording medium acquisition function to acquire information about the kind of print sheet and acquires the kind of print sheet set in the printing device 2 and controls the data conversion module 120 based on the information.

The print data transmitter 112 is a module configured to include print data (drop data) converted in the data conversion module 120 in job data as final print data and to send out the job data to the printing device 2.

The data conversion module 120 is a module group configured to perform data conversion processing from document data into drop data and as shown in FIG. 3, includes a mode switcher 121, an image data acquirer 122, a color converter 123, a data replacer 124, a halftone processor 125, and a data compressor 126. The image data acquirer 122 is a module configured to acquire image data relating to image formation and to transmit image data acquired from the application software to the mode switcher 121 and the color converter 123.

The mode switcher 121 is a module configured to select one of the standard mode and the data compression mode and to switch the orders of processing of image data output from the image data acquirer 122 in accordance with the selected mode. Note that the data compression mode includes a first data compression mode in which data compression (binarization) is performed before performing value multiplexing into drop data and a second data compression mode in which data compression (binarization) is performed after performing value multiplexing into drop data.

The standard mode is a mode in which image data acquired in the image data acquirer 122 is input to the halftone processor 125 as it is to generate drop data, which is the normal data conversion processing performed generally in the printing device. On the other hand, the first data compression mode of the data compression mode is a mode in which after image data acquired in the image data acquirer 122 is input to the data replacer 124 and replaced with a pixel pattern caused to have multiple values of predetermined gradations (here, two values), drop data is generated in the halftone processor 125. Here, the “pixel pattern” is, for example, a pattern indicating the arrangement of pixels of the same gradation calculated by performing binarization processing etc. Furthermore, the second data compression mode is a mode in which after image data acquired in the image data acquirer 122 is input to the halftone processor 125 to generate drop data, the drop data is replaced with a pixel pattern in the data replacer 124.

The switching between the standard mode and the data compression mode is determined based on each condition of the printing setting data. For example, it may also be possible to set a threshold value by which the modes are switched in accordance with the data file capacity and to make it possible to automatically determine which mode to use depending on whether the data file capacity is larger or smaller than the predetermined threshold value. Specifically, when the data file capacity is larger than the threshold value, it may also be possible to select the data compression mode in order to increase the compression rate. On the contrary, when the data file capacity is smaller than the predetermined threshold value, when a photo is included in a document image, or when a photo the color information of which includes a flesh color is included in a document image, it may also be possible to select the standard mode in order to give priority to the quality of the image. Note that, in order to determine color information within the image data, it may also be possible, for example, to use the automatic document color determination (ACS) function, to automatically determine by referring to the file extension, or to determine manually by a user's operation.

The color converter 123 is a module configured to perform digital signal processing specialized in image processing and to convert image data acquired from the image data acquirer 122 into print data including image data. Specifically, the color converter 123 converts the RGB value [0 to 255] of image data into the CMYK value [0 to 255]. The color converter 123 is controlled by the mode switcher 121 and sends out print data (CMYK value [0 to 255]) to the halftone processor 125 when the control signal from the mode switcher 121 is the standard mode at the time of normal printing or the second data compression mode. On the other hand, when the control signal from the mode switcher 121 is the first data compression mode, the color converter 123 sends out the print data (CMYK value [0 to 255]) to the data replacer 124.

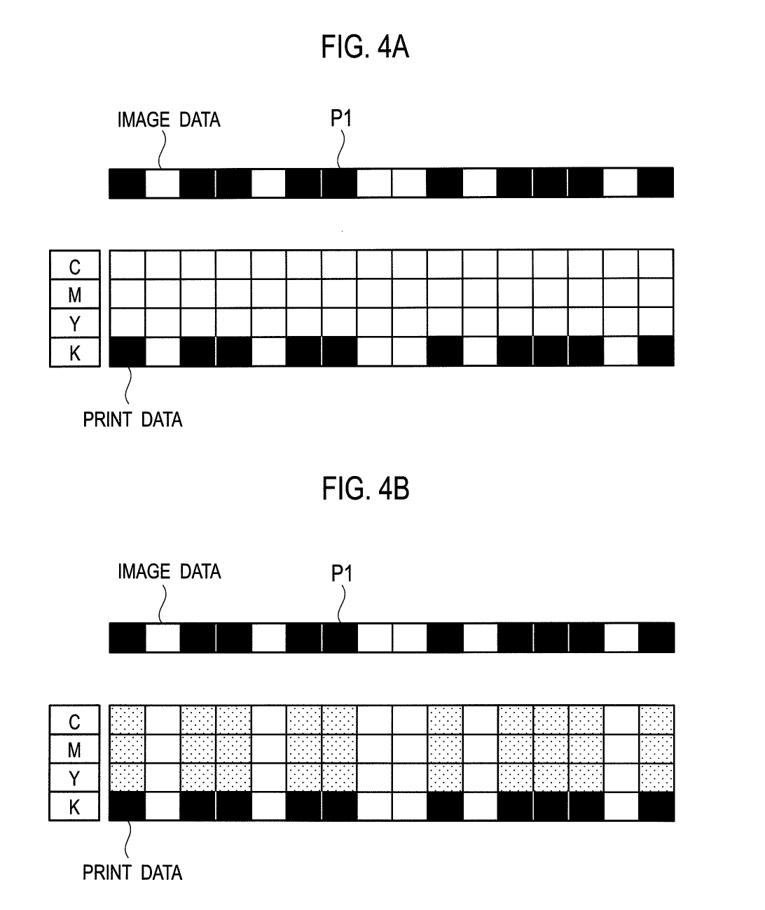

Further, the color converter 123 includes the function to replace a composite print portion with a single color print. Specifically, the color converter 123 is controlled by the mode switcher 121 so as to convert a pixel formed by combining a plurality of colors into a pixel the same color as that of the combined pixel and having a single color during the processing sequence of image data Details are as follows. In the image region including input image data, a black solid portion P1 is included, which is printed by combining the K ink and the CMY inks, that is, by so-called composite printing. If the black solid portion by such composite printing is printed using the CMY inks, pixels the amount of ink of which is 0 and pixels the amount of ink of which is 0 or more are interspersed as shown in FIG. 4B, and as a result, the drop data of the same gradation appears no longer continuously and the compression rate is reduced.

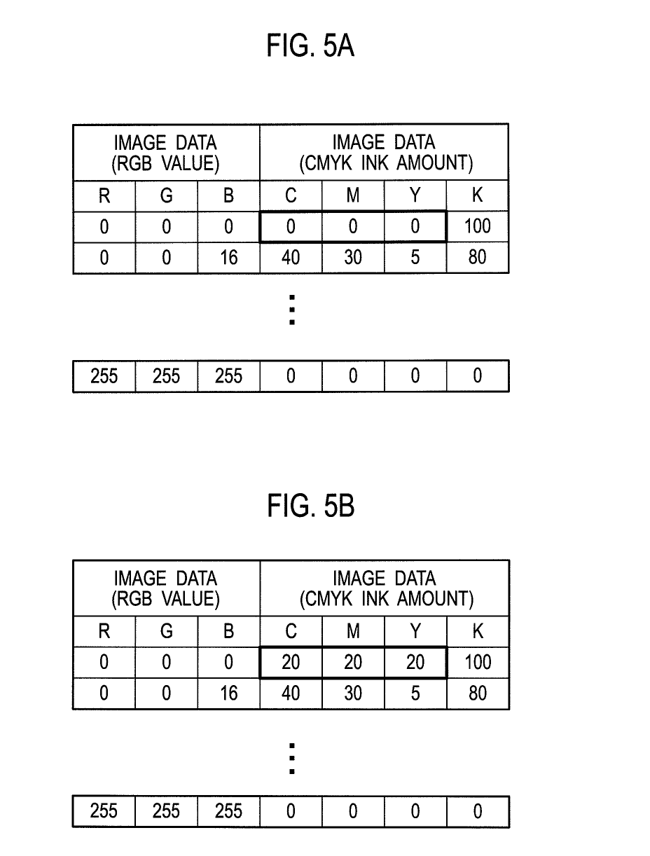

Consequently, in the present embodiment, the image data of the black solid portion P1 subjected to composite printing by a combination of the K ink and the CMY inks is converted so that printing is performed using only the single K ink, which is black, the same color as that of the pixel as shown in FIG. 4A. Specifically, for example, as shown in FIG. 5B, the print data of the pixel portion, in which CMYK ink amounts are such that C value=20, M value=20, Y value=20, and K value=100, is converted into print data in which C value=0, M value=0, Y value=0, and K value=100 as shown in FIG. 5A and only the K ink is used, and in the portions of the CMY inks, 0-drop data is made to appear continuously.

It may also be possible for the mode switcher 121 to determine whether or not to perform the single color conversion processing in accordance with the kind of print sheet. Specifically, when the print sheet is a glossy sheet or matted sheet having a small dot gain, it is determined to use the CMY inks because the reproduction rate of printed matter is low only by the K ink, and when the print sheet is a normal sheet having a large dot gain, it is determined to perform the single color conversion processing because the reproduction rate of printed matter is high only by the K ink.

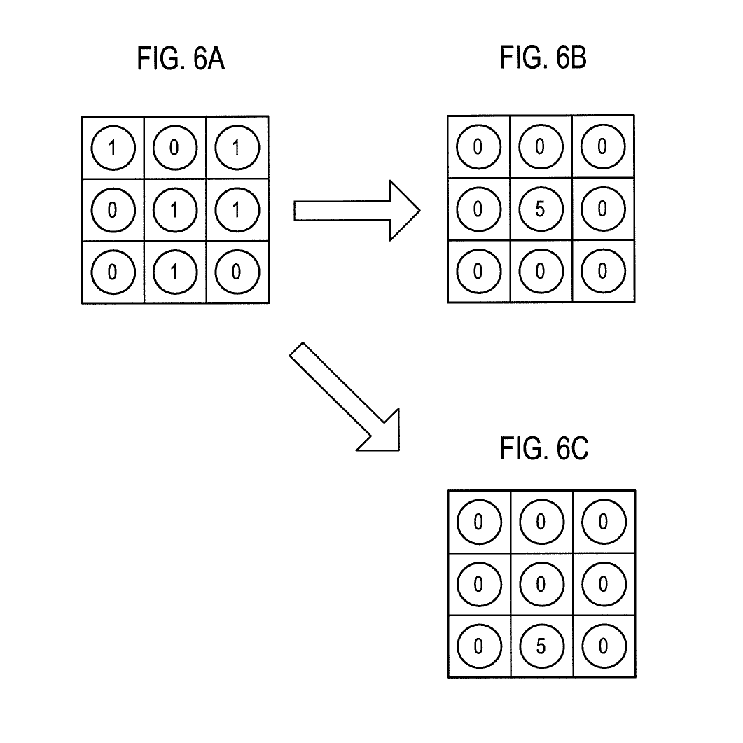

The data replacer 124 is a module configured to replace information about the density of each pixel in image data (CMYK value [0 to 255]) with a predetermined number of gradations. Specifically, as shown in FIG. 6, the data replacer 124 divides the image data into unit areas with a predetermined size (for example, in the case of FIG. 6, 3×3 pixels), calculates a pixel pattern (for example, matrix arrangement: 000050000 shown in FIG. 6B) in which pixels of the same gradation appear continuously for each unit area in accordance with the density in each unit area, and replaces each pixel value (similarly, matrix arrangement: 101011010) included in the unit area with the pixel pattern (matrix arrangement: 000050000) calculated for the unit area. Then, by calculating such a pixel pattern for the whole of the region of the image data and performing replacement, the replacement (conversion) of the pixel pattern for the whole of the image data is performed.

That is, in the present embodiment, the data replacer 124 calculates a pixel pattern by binarizing print data. The binarization processing uses a technique, such as the error diffusion processing in which an error that occurs in the previous pixel is added to the next pixel and the shading level of each pixel is compared with a threshold value and the ordered dither method in which a predetermined dither matrix is superposed on image data and the shading level of each corresponding pixel is compared with a threshold value.

Particularly, in the present embodiment, when multi-valued drop data (Drop value [0 to 5]) is input by the second data compression mode, the data replacer 124 calculates a pixel pattern by performing binarization processing while maintaining the density in each unit area. Specifically, when 1-drop data occurs in five pixels of a unit area of 3 pixels×3 pixels and the unit area has a density corresponding to that of five drops as a whole as shown in FIG. 6A, the unit area is replaced with a pixel patter in which 5-drop data is located in the center pixel of the unit area and in the rest of the unit area, 0-drop data is located, and thus, a density corresponding to that of five drops is secured as a whole. Further, for example, as shown in FIG. 6C, a pixel pattern may be, for example, such a pattern in which as in the error diffusion method, an error that occurs in the previous pixel is added to the next error while comparing each pixel with a threshold value in order from the top-left pixel in the rightward direction and then in the downward direction and 5-drop data is located in the pixel in which five drops are accumulated.

Note that data replacement of multi-valued drop data (Drop value [0 to 5]) is not limited to those and for example, when the density is uneven and high on one side of the divided unit area with a predetermined size, it may also be possible to plot 5-drop data on the high density side in the unit area.

Then, when the first compression mode is selected by the control of the mode switcher 121, the data replacer 124 binarizes multi-valued print data (CMYK value [0 to 255]) input from the color converter 123 and transmits the binarized print data (CMYK value [0 or 255]) to the halftone processor 125. On the other hand, when the second data compression mode is selected, the data replacer 124 generates binarized drop data (Drop value [0 or 5]) by binarizing drop data (Drop value [0 to 5]) input from the halftone processor 125 and transmits the drop data (Drop value [0 or 5]) to the data compressor 126.

The halftone processor 125 is a module configured to generate gradation data for printing by converting information about the density of each pixel in image data into information about printing gradation at the time of image formation. Here, the gradation data for printing in the present embodiment indicates the number of liquid drops of ink ejected in an inkjet printer and the number of liquid drops is generated as drop data. In the present embodiment, it is designed so that drop data of 0-drop to 5-drop is generated stepwise in correspondence to the value of CMYK (0 to 255) of print data.

Specifically, when the standard mode is selected by the control of the mode switcher 121, the halftone processor 125 converts multi-valued print data (CMYK value [0 to 255]) input from the color converter 123 into multi-valued drop data (Drop value [0 to 5]) and transmits the drop data (Drop value [0 to 5]) to the data compressor 126.

On the other hand, when the first compression mode is selected by the control of the mode switcher 121, the halftone processor 125 coverts binarized print data (CMYK value [0 or 255]) input from the data replacer 124 into drop data (Drop value [0 or 5]) and transmits the drop data to the data compressor 126. Further, when the second data compression mode is selected by the control of the mode switcher 121, after converting multi-valued print data (CMYK value [0 to 255]) input from the color converter 123 into drop data (Drop value [0 to 5]), the halftone processor 125 transmits the drop data to the data replacer 124.

The data compressor 126 is a module configured to compress input drop data and in the present embodiment, the run length compression is used, in which a certain identical gradation that appears continuously is represented by the gradation and the number of times the gradation appears continuously. It should be noted that the compression method is not limited to the run length compression and it is possible to use various kinds of compression method publicly known.

(Operation of Data Conversion)

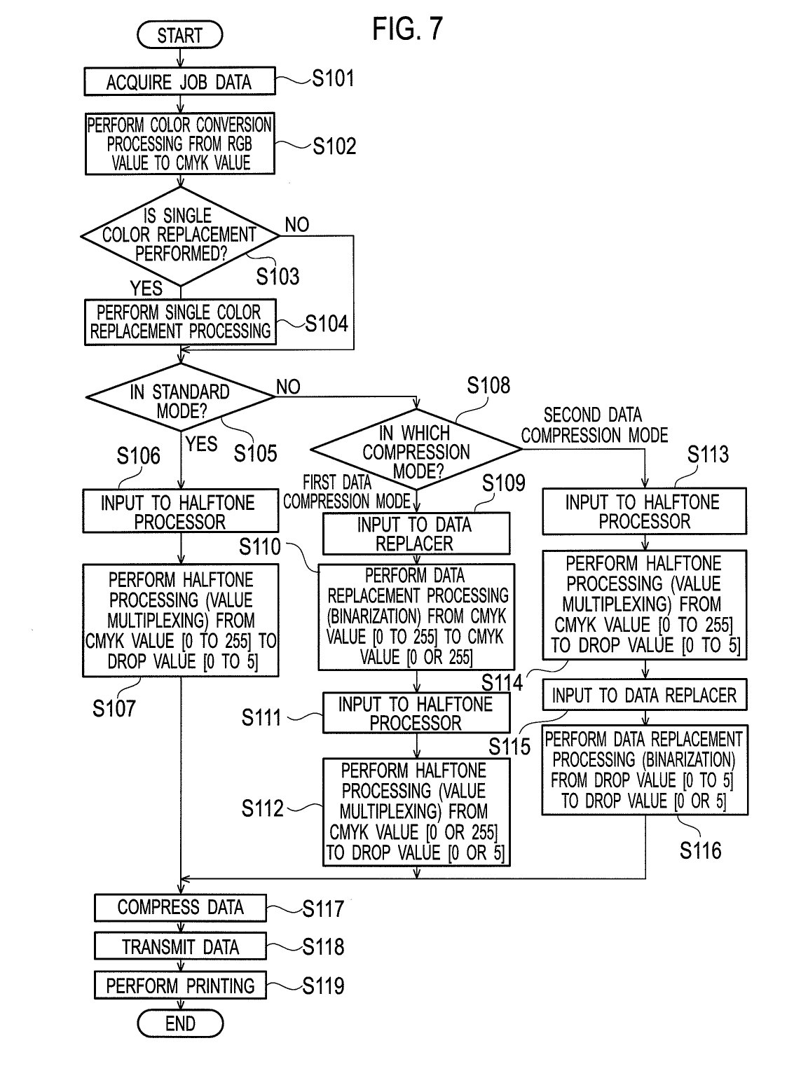

By operating the data conversion module 120 having the above-described configuration, it is possible to perform data conversion according to the present embodiment. FIG. 7 is a flowchart showing an outline of printing processing according to the present embodiment.

First, when printing processing is performed in the user terminal 1, the image data acquirer 122 on the printer driver 110 acquires image data (step S101) and transmits the image data to the mode switcher 121 and the color converter 123. The color converter 123 converts the input image data (RGB value [0 to 255]) into multi-valued print data (CMYK value [0 to 255]) (step S102). On the other hand, the mode switcher 121 refers to the printing setting data of the input image data and determines whether or not to perform single color conversion processing (step S103).

When determining to perform single color conversion processing (YES at step S103), the mode switcher 121 controls the color converter 123 to convert print data so that the image region of the black solid portion of an image to be printed by combining the K ink and the CMY inks is printed only by the single K ink, which is black and the same color as that of the pixel (step S104), and determines the mode relating to data conversion from the printing setting data. On the other hand, when determining not to perform single color conversion processing (NO at step S103), the mode switcher 121 determines the mode relating to data conversion from the printing setting data without performing anything else.

First, the mode switcher 121 determines whether or not to convert print data in the standard mode (step S105). When determining to convert data in the standard mode (YES at step S105), multi-valued print data (CMYK value [0 to 255]) is input from the color converter 123 to the halftone processor 125 (step S106). Then, the print data is converted into multi-valued drop data (Drop value [0 to 5]) (step S107). After that, the drop data is transmitted to the data compressor 126 and subjected to compression processing by the run length compression (step S117).

On the other hand, when determining not to convert data in the standard mode (NO at step S105), the mode switcher 121 determines in which data compression mode data is converted (step S108). When the first compression mode is selected (“first data compression mode at step S108), data conversion processing is performed in the first data compression mode. Specifically, multi-valued print data (CMYK value [0 to 255]) is input from the color converter 123 to the data replacer 124 (step S109). Then, the print data is binarized in the data replacer 124 (step S110) and the binarized print data (CMYK value [0 or 255]) is input to the halftone processor 125 (step S111). In the halftone processor 125, the two-valued print data (CMYK value [0 or 255]) is converted into two-valued drop data (Drop value [0 or 5]) (step S112). After that, the drop data is transmitted to the data compressor 126 and subjected to compression processing by the run length compression (step S117).

When the second data compression mode is selected (”second data compression mode” at step S108), data conversion processing is performed in the second data compression mode. Specifically, multi-valued print data (CMYK value [0 to 255]) is input from the color converter 123 to the halftone processor 125 (step S113). Then, the print data is converted into multi-valued drop data (Drop value [0 to 5]) (step S114) and the converted multi-valued drop data (Drop value [0 to 5]) is input to the data replacer 124 (step S115). In the data replacer 124, the multi-valued drop data (Drop value [0 to 5]) is binarized into two-valued drop data (Drop value [0 or 5]) (step S116) and the drop data is transmitted to the data compressor 126. In the data compressor 126, the drop data is subjected to compression processing by the run length compression (step S117).

Then, the compressed drop data is included in job data and sent out from the print data transmitter 112 to the printing device 2 (step S118) and in the printing device 2, printing processing is performed based on the drop data (step S119).

(Modified Example)

The present invention is not limited to the above-described embodiment and it is needless to say that there can be various modifications in accordance with designs etc. in the scope not deviating from the technical concept according to the present invention.

For example, in the present embodiment, print data (CMYK value [0 to 255]) is binarized in the data replacer 124 to generate a pixel pattern, but the present invention is not limited to this and it may also be possible to generate a pixel pattern of three or more gradations, such as a three-valued pixel pattern having, for example, 0-drop, 3-drop, or 5-drop data. It may also be possible to automatically select the processing in the data replacer 124 in accordance with the printing mode within the printing setting data, the size of document data, resolution, the size of a print sheet, and the kind of sheet, or it may also be possible to enable a user to arbitrarily select by the user's operation. For example, it may also be possible to set a threshold value for the data file capacity and to select binarization in order to increase the compression rate when the data file capacity is larger than the predetermined threshold value, and to select value multiplexing for three- or more-valued data by taking image quality into consideration when the data file capacity is smaller than the threshold value, or when a photo is included in image data, or when a flesh color is included in color information. Note that, in order to determine color information within the image data, it may also be possible, for example, to use the automatic document color determination (ACS) function, to automatically determine by the file extension, or to respond to a user's operation.

Moreover, in the present embodiment, the upper limit number of drops of a calculated pixel pattern is set to five, but the present invention is not limited to this and can be changed appropriately. In this case, the halftone processor 125 sets an upper limit of the number of drops within the unit area based on information relating to the print sheet that the controller 111 has acquired and calculates a pixel pattern by reducing the density of the pixels with a density exceeding the upper limit down to the upper limit. The selection of the upper limit value may be performed automatically in accordance with the kind of print paper or in accordance with a user's operation. It may also be possible to set setting conditions for automatic selection in such a manner that, for example, when the print sheet is a glossy sheet or matted sheet having a small dot gain, the upper limit of drop data is set to five in order to increase the reproduction rate of printed matter and when the print sheet is a normal sheet having a large dot gain, the upper limit of drop data is set to three.

Further, in the present embodiment, the composite and the single color replacement processing (step S103) are performed immediately after the color conversion processing (step S102), but may be performed after the processing by the halftone processor 125 and the data replacer 124.

Furthermore, in the present embodiment, the black solid portion is replaced uniformly with the same pixel pattern and compressed, but it may also be possible to improve visibility by replacing the contour portion of the black solid portion with a pixel pattern having been subjected to edge enhancement processing.

(Data Conversion Program)

It is possible to implement the data conversion unit according to the present embodiment by executing programs described in a predetermined language on a computer. By installing such programs in a user terminal, such as a personal computer, or a printing device and by executing the programs on a CPU, it is possible to easily construct the data conversion unit having each function described above. It is possible to implement such programs as firmware of a router device, in addition to applications, driver software, and OS executed on a personal computer.

It is also possible to record such programs in a recording medium that can be read by a general-purpose computer. Specifically, it is possible to record in various kinds of recording medium, such as a magnetic recording medium, such as a flexible disk and cassette tape, an optical disk, such as a CD-ROM and DVD-ROM, a RAM card, etc.

Then, with a computer-readable recording medium recording these programs, it is possible to easily save, carry, and install the programs. With such data conversion programs, it is possible to simply cause an already existing information processing device to function as the above-described data conversion unit without requiring a special processing device.

(Working/Effect)

According to the present embodiment, when converting document image data into gradation data for printing, the standard mode and the data compression mode (the first data compression mode, the second data compression mode) are selected and used appropriately. Therefore, for example, when the data compression mode is selected, it is possible to generate input image data as binarized drop data (Drop value [0 or 5]), and therefore, the continuity of the drop data (Drop value [0 or 5]) of the same gradation is made greater. Due to this, it is possible to reduce the file capacity by performing compression using a normal compression algorithm. Consequently it is possible to increase the speed of data transfer from the user terminal 1 to the printing device 2 and to prevent a reduction in the substantial printing processing speed of the printing device 2.

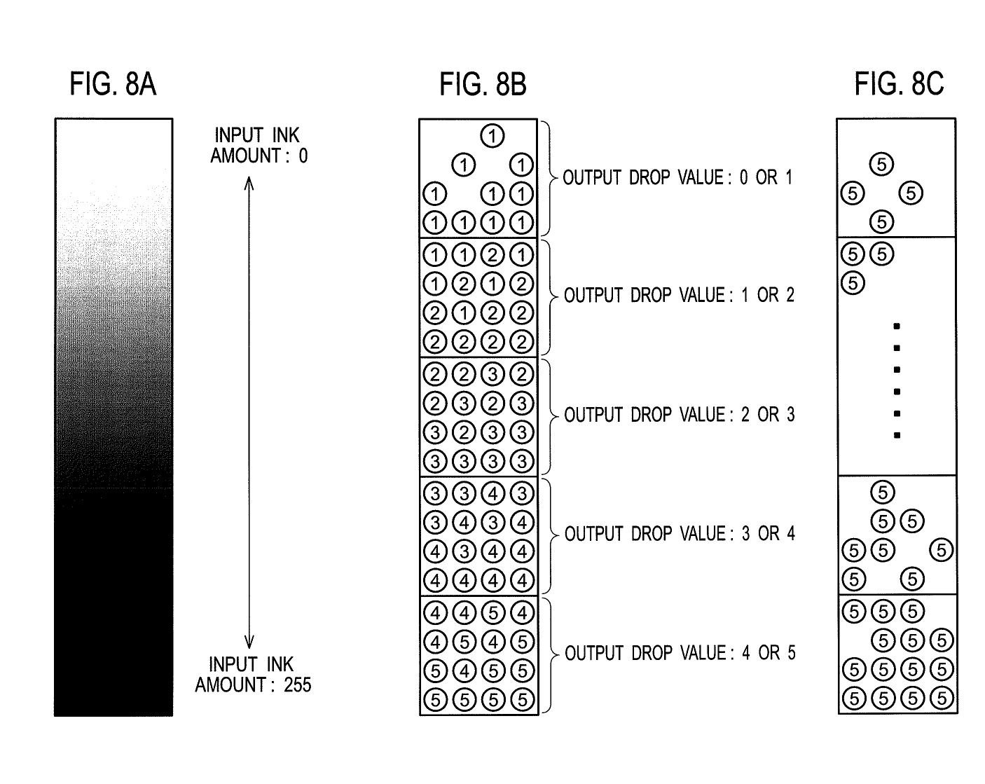

Specifically, for example, as shown in FIG. 8A, when image data is a gradation visually representing the change in level of gradation, if processing is performed in the standard mode, the drop data to be output is also caused to have multiple values as shown in FIG. 8B. Therefore, the probability that the same drop data value appears continuously is reduced and due to this, the file capacity of the drop data tends to increase. In contrast to this, when the data compression mode (the first data compression mode, the second data compression mode) is used, as shown in FIG. 8C, the two-valued drop data, that is, 0-drop data or 5-drop data, is generated. Therefore, the probability that the same drop data value appears continuously is increased and even if a normal compression algorithm is used, it is possible to reduce the file capacity.

In particular, in the present embodiment, the mode switcher 121 is capable of selecting the second data compression mode also, and therefore, it is possible to perform binarization processing of multi-valued drop data (Drop value [0 to 5]) as shown in FIG. 8B. Therefore, it is possible to increase the data transfer speed only by updating the version of already existing software, such as a driver, and therefore, it is possible to prevent a reduction in the substantial printing processing speed of the printing device.

Further, when calculating a pixel pattern in which pixels of the same gradation appear continuously in accordance with the density in each unit area, the data replacer 124 calculates a pixel pattern by performing binarization while maintaining the density in each unit area. Therefore, as shown in FIG. 8B, even in the region where the drop value is 0 or 1, at least 5-drop data is located within the region as shown in FIG. 8C as a result, and therefore, it is possible to prevent deterioration of an image.

Furthermore, in the present embodiment, it is also possible to switch the data conversion processing in the standard mode, and therefore, it is possible to acquire printed matter based on the drop data as shown in FIG. 8B. Therefore, for example, when image data includes a photo or the number of sheets to be printed is small, it is possible to acquire printed matter with less deterioration of image quality, and therefore, it is possible to provide printed matter intended by a user.

Moreover, according to the present embodiment, based on information about the kind of print sheet, an upper limit of drop data in the unit area is set and the density of the pixels with a density exceeding the upper limit is reduced down to the upper limit, and then, a pixel pattern is calculated. Therefore, for example, by lowering the upper limit of gradation data for printing for a normal sheet having a large dot gain and by raising the upper limit of gradation data for printing for a glossy sheet or matted sheet etc. having a small dot gain, it is possible to guarantee the image quality of printed matter to be acquired.

Further, according to the present embodiment, the color converter 123 replaces a pixel formed by combining a plurality of colors with a pixel of the same color as that of the pixel and having a single color. Therefore, for example, in the image region in which the black solid portion of an image is printed by combining the K ink and the CMY inks, that is, in the composite region, the drop data of the CMY inks occurs as shown in FIG. 4B, and therefore, the continuity of the drop data tends to be lost. However, in the present embodiment, as shown in FIG. 4A, the number of CMY drops is set to zero, and therefore, the continuity of drop data of the same gradation of the CMY inks is made greater and it is possible to increase the compression rate of transfer data.

### Second Embodiment

Next, a second embodiment of the image data conversion unit according to the present invention is explained. In the first embodiment, the data conversion unit is configured by installing a data conversion program in the user terminal 1 (1a to 1c) as a driver. However, in the present embodiment, a case is explained as an example, in which the data conversion unit is constructed virtually by installing the data conversion program in the printing device 2. In the present embodiment also, an inkjet line color printer is supposed as the printing device 2.

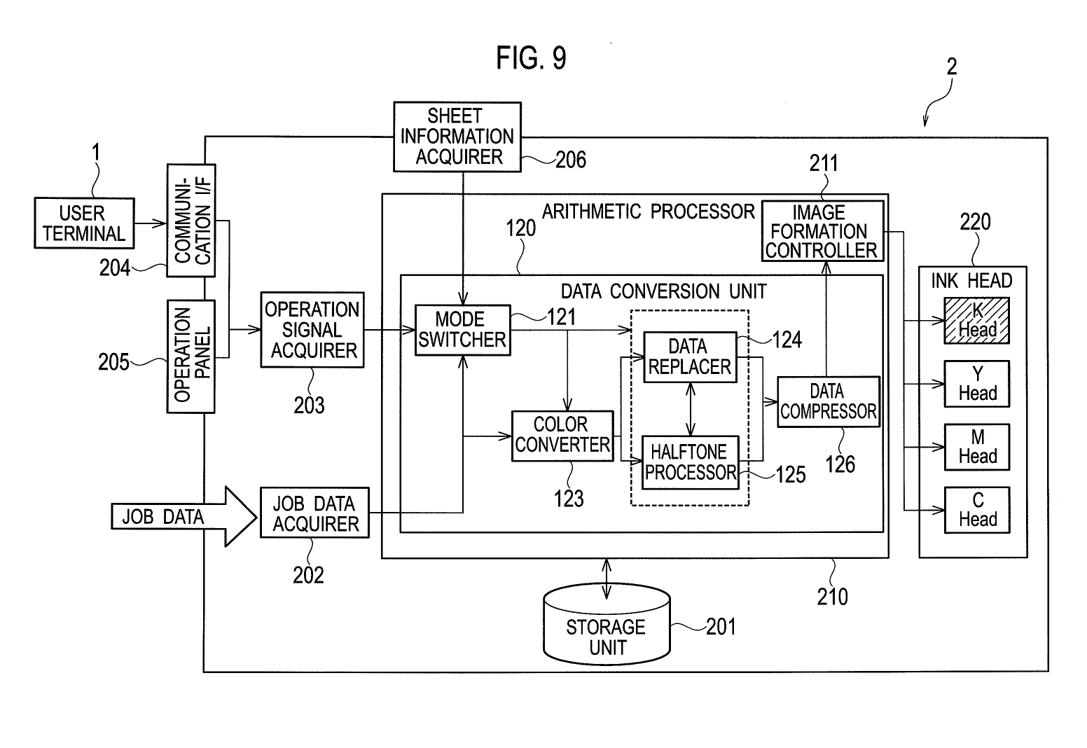

FIG. 9 is a block diagram showing an internal module of the printing device 2 according to the second embodiment. Note that, in the present embodiment, the same symbols are attached to the same components as those in the embodiment described above and the functions etc. thereof are the same unless referred to otherwise and explanation thereof is omitted.

As shown in FIG. 9, the printing device 2 includes a job data receiver 202, a storage unit 201, an operation signal acquirer 203, an ink head 220, which is a printer, and an arithmetic processor 210.

The job data receiver 202 is a communication interface configured to receive job data, a series of printing processing units, and is a module configured to receive and deliver image data (RGB [0 to 255]) included in the received job data to an arithmetic processor 210. In the above-mentioned job data, resolution, number of sheets to be printed, sheet size, etc., are included, in addition to print image data defined by RGB.

The operation signal acquirer 203 is a module configured to receive an operation signal by a user through an operation panel 205 and a communication interface 204 and analyzes a received operation signal and causes another module to perform processing in accordance with the user's operation. In particular, in the present embodiment, the operation signal acquirer 203 receives printing setting data, and an instruction operation of data conversion processing and a setting operation by a user from the operation panel 205, the printer driver 110 connected via the communication interface 204, etc.

A sheet information acquirer 206 is a module configured to acquire sheet settings received from the operation panel 205 and the communication interface 204 and information about the kind of print sheet detected by a sheet detecting mechanism and to send out the information to the arithmetic processor 210.

An image formation controller 211 is a module configured to control the whole of image formation processing to form an image by controlling the drive of the ink head 220 of each ink and the operation of the driver of the transfer path based on the drop data input from the data compressor 126.

The arithmetic processor 210 is an arithmetic module configured by hardware, that is, a processor, such as CPU and DSP (Digital Signal Processor), a memory, and other electronic circuits, or software, such as programs having the functions of the hardware, or a combination thereof. The arithmetic processor 210 constructs various kinds of function modules virtually by appropriately reading and executing programs and performs processing relating to image data, controls the operation of each component, and performs various kinds of processing for user's operations by each of the constructed function modules. Further, to the arithmetic processor 210, the operation panel 205 is connected and it is possible to receive an instruction and a setting operation by a user through the operation panel 205.

Then, the arithmetic processor 210 constructs the data conversion module 120 virtually by reading the data conversion program and performs data conversion of image data included in the job data received by the job data receiver 202. Specifically, by the control of the mode switcher 121 within the arithmetic processor 210, one of the standard mode and the data compression mode (the first data compression mode, the second data compression mode) is selected. Then, in accordance with the selected mode, the color converter 123, the data replacer 124, and the halftone processor 125 perform data conversion of the image data (RGB [0 to 255]) input from the job data receiver 202 into two-valued drop data (Drop value [0 or 5]) or multi-valued drop data (Drop value [0 to 5]).

In the present embodiment also, the standard mode is a mode in which drop data is generated by inputting the image data acquired in the image data acquirer 122 to the halftone processor 125. In addition, the first data compression mode is a mode in which drop data is generated in the halftone processor 125 after generating a pixel pattern by inputting the image data acquired in the image data acquirer 122 to the data replacer 124 and performing binarization. Further, the second data compression mode is a mode in which after generating drop data by inputting the image data acquired in the image data acquirer 122 to the halftone processor 125, the drop data is input to the data replacer 124, binarized, and replaced with a pixel pattern.

Then, the data converted into the two-valued drop data (Drop value [0 or 5]) or into the multi-valued drop data (Drop value [0 to 5]) is subjected to compression processing in the data compressor 126 and after being input to the image formation controller 211, printing processing is performed at a predetermined timing.

According to the second embodiment as described above, it is possible to generate binarized drop data (Drop value [0 or 5]) in the printing device 2, and therefore, the continuity of the drop data of the same gradation is made greater and it is possible to reduce the file capacity. Due to this, it is possible to transmit drop data with a high degree of compression to the image formation controller 211 that performs printing processing, and therefore, it is possible to prevent a reduction in the substantial printing processing speed of the printing device 2 by sending out the drop data in synchronization with the speed of printing performed in the image formation controller 211.

Note that it may also be possible to configure the embodiment so that the first data compression mode or the second data compression mode is not used when it is not necessary to compress data in order to prevent a reduction in the printing processing speed because the capacity of image data is originally small, or when image data includes an object with a high resolution, such as a photo, etc. Due to this, it is possible to prevent unnecessary compression processing from being performed and to prevent an object with a high resolution from being printed at a resolution lower than necessary.

As explained above, according to the image data conversion unit according to the first and second embodiments described above, when the mode switcher selects data conversion by the data compression mode converter, data is converted into gradation data for printing smaller in the number of gradations than that in the case of data conversion by the standard mode converter and is compressed in the data compressor. Consequently, in the gradation data for printing compressed by the data compressor, the continuity of the number of gradations between neighboring pixels is made relatively greater compared with that in the case of the data conversion by the standard mode converter. Therefore, even if a general data compression method is used instead of using a data compression method with a special algorithm, it is possible to increase the compression efficiency in the data compressor. Consequently, it is possible to aim at an increase in the printing processing speed by making it easy to synchronize the data transfer of gradation data for printing with printing processing in the image forming device.

Further, it is also possible to select data conversion by the standard mode converter in which the number of gradations of the gradation data for printing is not reduced, and therefore, it is possible to acquire printed matter with less deterioration of image quality by appropriately selecting data conversion by the data compression mode and by using data conversion by the standard mode converter depending on circumstances, and therefore, it is possible to provide printed matter intended by a user.

Further, according to the image data conversion unit according to the embodiments described above, it is possible to acquire printed matter with less deterioration of image quality by using data conversion by the standard mode converter when, for example, a document image includes a photo or when the number of documents is small and the capacity of document image data is small, and therefore, it is possible to provide printed matter intended by a user.

Further, according to the image data conversion unit according to the embodiments described above, for example, in the case of an inkjet printer, it is possible to implement conversion by the data compression mode converter into gradation data for printing smaller in the number of gradations than the predetermined number of gradations by temporarily converting the drop data into gradation data for printing in the predetermined number of gradations by data conversion by the standard mode converter and by subjecting the data to binarization processing etc. Therefore, it is possible to increase the data transfer speed only by updating the version of already existing software, such as a driver, and therefore, it is possible to prevent a reduction in the substantial printing speed of the image forming device

Further, in the image data conversion unit according to the embodiments described above, the number of gradations (predetermined number of gradations) of data conversion by the standard mode converter is determined in accordance with the kind of recording medium and data conversion by the data compression mode converter is performed with a number of gradations smaller than that. Therefore, it is possible to guarantee image quality of printed matter acquired in accordance with a recording medium by, for example, reducing the predetermined number of gradations for a normal sheet having a large dot gain in an inkjet printer, by increasing the predetermined number of gradations for a glossy sheet or a matted sheet etc. having a small dot gain.

Further, according to the image data conversion unit according to the embodiments described above, when the image forming device performs composite printing of the black solid portion of an image by combining an achromatic color ink (K (black)) and chromatic color inks (C (cyan), M (magenta), Y (yellow)), in the data compression mode, the number of gradations of the chromatic color inks in the gradation data for printing is set to zero. Therefore, in the data compression mode, it is possible to perform data compression with high efficiency if only the number of gradations of the achromatic color ink is continuous between neighboring pixels. Consequently, it is possible to further increase data compression efficiency of gradation data for printing by the data compression mode.

The present application claims the benefit of priority under 35 U.S.C §119 to Japanese Patent Application No. 2011-212823, filed on Sep. 28, 2011, the entire content of which is incorporated herein by reference.

What is claimed is:

1. An image data conversion unit converting document image data into gradation data for printing in accordance with the density of each pixel and outputting the data after compression processing, comprising:
a standard mode converter configured to convert the document image data into the gradation data for printing in a predetermined number of gradations;
a data compression mode converter configured to convert the document image data into the gradation data for printing in a number of gradations smaller than the predetermined number of gradations so that continuity of the number of gradations between neighboring pixels is made greater;
a mode switcher configured to select one of the data conversion by the standard mode converter and the data conversion by the data compression mode converter; and
a data compressor configured to perform compression processing of the gradation data for printing using the data conversion in the mode selected by the mode switcher.

2. The image data conversion unit according to claim 1, wherein
the mode switcher performs the selection processing in accordance with the capacity of the document image data or contents of an object included in the document image data.

3. The image data conversion unit according to claim 1, wherein
the data compression mode converter has a data replacer configured to divide the gradation data for printing converted in the standard mode converter into a plurality of unit size areas and to determine a gradation value of each pixel in each unit size area with a number of gradations smaller than the predetermined number of gradations so as to preserve the total gradation value of the pixels in each unit size area.

4. The image data conversion unit according to claim 1, wherein
the predetermined number of gradations is a number of gradation determined in accordance with the kind of a recording medium used to print a document image.

5. The image data conversion unit according to claim 1, wherein
as to a pixel corresponding to a portion to be printed in black by an achromatic ink and chromatic inks in a document image, the data compression mode converter generates gradation data for printing by the data compression mode in which the number of gradations of a data portion corresponding to the chromatic inks is set to zero.
